(19) United States
(12) Patent Application Publication
(10) Pub. No.: US 2012/0168685 A1
(43) Pub. Date: Jul. 5, 2012

(54) METHOD OF POST-TREATING CONDUCTIVE FILM AND CONDUCTIVE FILM USING THE SAME

(75) Inventors: Youn Soo Kim, Seoul (KR); Yong Hyun Jin, Seoul (KR); Sang Hwa Kim, Suwon (KR)

(73) Assignee: SAMSUNG ELECTRO-MECHANICS CO., LTD., Gyunggi-do (KR)

(21) Appl. No.: 13/312,001

(22) Filed: Dec. 6, 2011

(30) Foreign Application Priority Data
Dec. 31, 2010 (KR) 1020100139984

(51) Int. Cl. H01B 1/12; B05D 3/10; B05D 3/00; B05D 5/12

(52) U.S. Cl. 252/500; 427/58

(57) ABSTRACT

Disclosed is a method of post-treating a conductive film by oxidizing the conductive film using dipping or spraying with an acid solution, so that the band gap of the conductive polymer is decreased, thus increasing the transmittance and electrical conductivity of the conductive film.

### CROSS REFERENCE TO RELATED APPLICATION

This application claims the benefit of Korean Patent Application No. 10-2010-0139984, filed Dec. 31, 2010, entitled “Post treatment method for conductive film and the conductive film using the same,” which is hereby incorporated by reference in its entirety into this application.

### BACKGROUND OF THE INVENTION

1. Technical Field

The present invention relates to a method of post-treating a conductive film and a conductive film using the same.

2. Description of the Related Art

Alongside the growth of computers using digital technology, devices assisting computers have also been developed, and personal computers, portable transmitters and other personal information processors are used to process text and graphics using a variety of input devices such as keyboards, mouse elements and so forth.

The rapid advancement of the information-based society, which is disseminating the use of computers, is accompanied by the problem of difficulty in efficiently operating products using only the keyboard and the mouse to perform the functions of an input device. Accordingly, there is increasing demand for devices which are simple and infrequently malfunction, and which enable information to be easily input by anyone.

Furthermore, technology for input devices has surpassed the mere level of fulfilling general functions and has progressed toward technology related to high reliability, durability, innovation, designing and manufacturing. To this end, touch panels have been developed as devices capable of inputting information such as text and graphics.

The touch panel is mounted on the display surface of an image display device such as a flat panel display including an electronic organizer, a liquid crystal display (LCD), a plasma display panel (PDP), an electroluminescence (El) element etc., or a cathode ray tube (CRT), so that a user selects the information desired while looking at the image display device.

Also, touch panels are generally classifiable as being of a resistive type, a capacitive type, an electromagnetic type, a SAW (Surface Acoustic Wave) type, and an infrared type. The type of touch panel selected is one that is adapted for an electronic product in consideration of signal amplification problems, resolution differences, the degree of difficulty of designing and manufacturing technology, optical properties, electrical properties, mechanical properties, resistance to the environment, input properties, durability and economic benefits of the touch panel. In particular, resistive touch panels and capacitive touch panels are widely and prevalently used in different fields.

In the case of resistive touch panels, they are configured so that upper/lower transparent electrode films are separated from each other by a spacer and are brought into contact with each other by pressing. Particularly useful are digital resistive type and analog resistive type in such a manner that when an upper conductive film having the upper transparent electrode film is pressed by an input element such as a finger, a pen, etc., the upper/lower transparent electrode films are electrically connected with each other, and changes in voltage in response to changes in resistance at the touch position are sensed by the controller to thus recognize the touch coordinates.

In the case of capacitive touch panels, an upper conductive film having a first transparent electrode and a lower conductive film having a second transparent electrode are spaced apart from each other, and an insulating material is interposed between the first transparent electrode and the second transparent electrode so that these transparent electrodes do not come into contact with each other. Furthermore, electrode wires which are connected to the transparent electrodes are formed on the upper conductive film and the lower conductive film. The electrode wires transfer changes in capacitance occurring from the first transparent electrode and the second transparent electrode to the controller as the touch screen is touched by the input element.

The transparent electrodes have been conventionally formed using ITO (Indium Tin Oxide), but thorough research into conductive polymers as alternatives thereof is ongoing. The conductive polymers are advantageous because of higher flexibility and a simpler coating process, compared to ITO. Because of such advantages, the conductive polymers are receiving attention as an important element of flexible displays corresponding to next-generation technology, as well as the touch panels.

In the case where a transparent electrode is patterned on a base member using such a conductive polymer, the transmittance of the touch panel is undesirably decreased due to an inherent blue color of the conductive polymer.

Moreover, as the touch screen, display and so on are required to be small-sized and highly integrated, the electrical conductivity of the transparent electrode is regarded as very important. However, when a conductive polymer is used in lieu of ITO, comparatively low electrical conductivity of the conductive polymer is problematic.

### SUMMARY OF THE INVENTION

Accordingly, the present invention has been made keeping in mind the problems encountered in the related art and the present invention is intended to provide a method of post-treating a conductive film and a conductive film using the same, in which the conductive film is post-treated with an acid solution in order to increase transmittance and electrical conductivity.

An aspect of the present invention provides a method of post-treating a conductive film, comprising (A) providing a base member, (B) coating the base member with a conductive polymer composition and drying it, thus obtaining a conductive film, and (C) post-treating the conductive film with an acid solution.

In this aspect, post-treating may be performed using dipping or spraying.

In this aspect, post-treating may be performed for 5˜70 min.

In this aspect, the acid solution may have a concentration ranging from 0.5 m to 3 m.

In this aspect, the acid solution may be any one selected from among a hydrochloric acid (HCl) solution, a sulfuric acid (H₂SO₄) solution, and a nitric acid (HNO₃) solution.

In this aspect, the conductive polymer composition may comprise any one conductive polymer selected from among polythiophene-, polypyrrole-, polyphenylene-, polyaniline-, and polyacetylene-based conductive polymers.

In this aspect, the polythiophene-based conductive polymer may be polyethylenedioxythiophene/polystyrenesulfonate (PEDOT/PSS).

Another aspect of the present invention provides a conductive film, post-treated using the above method and having a sheet resistance of 500Ω/□ or less.

### DESCRIPTION OF SPECIFIC EMBODIMENTS

The features and advantages of the present invention will be more clearly understood from the following detailed description and embodiments. Furthermore, descriptions of known techniques, even if they are pertinent to the present invention, are considered unnecessary and may be omitted in so far as they would make the characteristics of the invention unclear.

Hereinafter, embodiments of the present invention will be described in detail

According to the present invention, a method of post-treating a conductive film includes (A) providing a base member, (B) coating the base member with a conductive polymer composition and drying it thus obtaining a conductive film, and (C) post-treating the conductive film with an acid solution. In the present invention, when the conductive film is post-treated with the acid solution, transmittance and electrical conductivity of the conductive film may be increased. Below, the method of post-treating the conductive film is sequentially described.

Specifically, the base member is first prepared. The base member should be transparent so that a supporting force is provided and an image of the display may be recognized by a user. Taking into consideration the supporting force and transparency, a material for the base member may include, but is not necessarily limited to, polyethyleneterephthalate (PET), polycarbonate (PC), polymethylmethacrylate (PMMA), polyethyleneenaphthalate (PEN), polyethersulfone (PES), cyclic olefin copolymer (COC), TAC (Triacetylcellulose) film, polyvinyl alcohol (PVA) film, polyimide (PI) film, polystyrene (PS), biaxially oriented polystyrene (BOPS containing K resin), glass or reinforced glass.

Next, the base member is coated with the conductive polymer composition and dried, thus manufacturing the conductive film.

The conductive polymer composition refers to a solution in which a conductive polymer is dissolved in a solvent, and may be mixed with other additives, such as a binder, a dopant, a dispersion stabilizer, and a surfactant.

The conductive polymer is an electrically conductive polymer having a single π-electron per carbon atom, with a molecular weight of about 10,000 or more. The conductive polymer is advantageous because a thin film that is lighter and more flexible may be obtained than when typically using ITO (Indium Tin Oxide) for a transparent electrode. Such a conductive polymer may be any one selected from among polythiophene-, polypyrrole-, polyphenylene-, polyaniline-, and polyacetylene-based conductive polymers.

A polythiophene-based conductive polymer is particularly useful, and is exemplified by polyethylenedioxythiophene/polystyrenesulfonate (PEDOT/PSS), for example, Clevios P available from H.C. Starck. This polyethylenedioxythiophene (PEDOT) is doped with a dopant namely polystyrenesulfonate (PSS) and is thus well-dissolved in water with very good thermal stability. Furthermore, in order to maintain the optimal dispersibility of PEDOT in water, PEDOT and PSS have a solid content of 1.0˜1.5 wt %. Further, because PEDOT may be mixed with water, alcohol or a solvent having high dielectric constant, it may be diluted with the solvent and thus may be easily applied. Also even when forming a coating film therefrom, this exhibits superior transparency to that of other conductive polymers, such as polyanilines, polypyrroles and so on.

The base member may be coated with the conductive polymer composition using a dry process or a wet process. The dry process includes sputtering, evaporation, etc., and the wet process includes dip coating, spin coating, roll coating, spray coating, etc.

The base member coated with the conductive polymer composition is dried using hot air drying, vacuum drying or IR drying, so that a transparent electrode in fixed form is provided on the base member.

Next, the conductive film is post-treated with the acid solution. When the conductive film is post-treated with the acid solution, the conductive polymer is oxidized, thereby increasing electrical conductivity and transmittance of the conductive film. Upon post-treatment of the conductive film with the acid solution, a band gap is decreased. In the band structure of a conductive polymer, the band gap is referred to as an energy level from the top of the highest energy band (valence band) occupied by electrons to the bottom of the lowest vacant band (conduction band) or the energy difference between them. Thus, the movement of electrons may use only a small amount of energy, thereby increasing electrical conductivity of the conductive film. Furthermore, as the band gap is decreased, absorbance in the visible range may be decreased, thus increasing the transmittance of the conductive film.

The conductive film may be post-treated using dipping or spraying with an acid solution. Dipping in which a conductive film is dipped in an acid solution for a predetermined period of time, or spraying for applying an acid solution onto a conductive film using a sprayer may be simply performed, and thus there is no need for an additional device. Such post-treatment using an acid solution is carried out for 5˜70 min. The optimal time range is 20˜50 min. The post-treatment time may vary depending on the concentration of the acid solution.

The acid solution may be a material for donating H⁺ ions in a solution of hydrochloric acid (HCl), sulfuric acid (H₂SO₄) or nitric acid (HNO₃). Also, the acid solution is a material able to receive an electron pair, for example Lewis acid such as AlBr₃. The present invention is not limited thereto, and the acid solution includes any material able to oxidize the conductive polymer.

The concentration of the acid solution is 0.5˜3 m (molality), the optimal concentration being 0.8˜2 m. If the concentration of the acid solution is less than 0.5 m, oxidation of the conductive polymer with the acid solution is insignificant. In contrast, if the concentration thereof is larger than 3 m, the conductive film may be damaged by the acid solution.

The conductive film according to the present invention may be obtained by applying the conductive polymer composition on the base member, drying it, and post-treating it with the acid solution. The conductive film subjected to post-treatment has a sheet resistance of 500Ω/□ or less, resulting in high electrical conductivity, and also has a high transmittance of 88.1% or more.

A better understanding of the present invention may be obtained via the following examples which are set forth to illustrate, but are not to be construed as limiting the present invention.

### Example 1

An acryl binder, and a conductive polymer for example a polyethylenedioxythiophene/polystyrenesulfonate (PEDOT/PSS) aqueous solution were added to an i-propanol organic solvent and mixed for about 1 hour, thus preparing a conductive polymer composition. The conductive polymer composition was composed of 60% i-propanol, 5% acryl binder, and 35% PEDOT/PSS. The prepared conductive polymer composition was applied on a base member using spin coating, and dried at about 100° C. for 5 min, thus manufacturing a conductive film. The conductive film was dipped in a 0.5 m HCl solution for 30 min and thus post-treated.

### Example 2

This example was performed in the same manner as in Example 1, with the exception that the conductive film was post-treated for 30 min using a 1 m HCl solution.

### Example 3

This example was performed in the same manner as in Example 1, with the exception that the conductive film was post-treated for 30 min using a 2 m HCl solution.

### Example 4

This example was performed in the same manner as in Example 1, with the exception that the conductive film was post-treated for 30 min using a 3 m HCl solution.

### Comparative Example

This example was performed in the same manner as in Example 1, with the exception that the PEDOT/PSS conductive film was not post-treated with an HCl solution.

### Test Example

The sheet resistance and transmittance of the conductive films which were post-treated with an acid solution in Examples 1 to 4 and the conductive film of Comparative Example were measured. The sheet resistance was measured using Loresta EP MCP-T360 available from Mitsubishi Chemical, and the transmittance was measured using CM-3500d available from Minolta.

TABLE 1

| | Sheet Resistance (Ω/□) | Transmittance (%) |
|---|---|---|
| Ex. 1 | 275 | 88.1% or more |
| Ex. 2 | 265 | 88.2% or more |
| Ex. 3 | 255 | 88.2% or more |
| Ex. 4 | 266 | 88.2% or more |
| C. Ex. | 1050 | 88% |

As is apparent from Table 1, the post-treated conductive film according to the present invention had lower sheet resistance and thus exhibited superior electrical conductivity and higher transmittance, compared to the conductive film not post-treated with an acid solution (Comparative Example). When the post-treatment was performed using the acid solution having a concentration ranging from 0.8 m to 2 m, significant improvements in electrical conductivity and transmittance were noted.

As described hereinbefore, the present invention provides a method of post-treating a conductive film and a conductive film using the same. According to the present invention, the conductive film is post-treated using an acid solution, so that the conductive polymer is oxidized, thereby increasing transmittance and electrical conductivity of the conductive film.

Also according to the present invention, the conductive film can possess a sheet resistance of 500Ω/□ or less.

Although the embodiments of the present invention regarding the method of post-treating a conductive film and the conductive film using the same have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A method of post-treating a conductive film, comprising:
(A) providing a base member;
(B) coating the base member with a conductive polymer composition and drying it, thus obtaining a conductive film; and
(C) post-treating the conductive film with an acid solution.

2. The method of claim 1, wherein the post-treating is performed using dipping or spraying.

3. The method of claim 1, wherein the post-treating is performed for 5˜70 min.

4. The method of claim 1, wherein the acid solution has a concentration ranging from 0.5 m to 3 m.

5. The method of claim 1, wherein the acid solution is any one selected from among a hydrochloric acid (HCl) solution, a sulfuric acid (H₂SO₄) solution, and a nitric acid (HNO₃) solution.

6. The method of claim 1, wherein the conductive polymer composition comprises any one conductive polymer selected from among polythiophene-, polypyrrole-, polyphenylene-, polyaniline-, and polyacetylene-based conductive polymers.

7. The method of claim 6, wherein the polythiophene-based conductive polymer is polyethylenedioxythiophene/polystyrenesulfonate (PEDOT/PSS).

8. A conductive film, post-treated using the method of claims 1 and having a sheet resistance of 500Ω/□ or less.
